(19) United States
(12) Patent Application Publication
(10) Pub. No.: US 2010/0114954 A1
(43) Pub. Date: May 6, 2010

(54) REALTIME POPULARITY PREDICTION FOR EVENTS AND QUERIES

(75) Inventors: BHRIGHU SAREEN, Redmond, WA (US); WILLIAM ALEXANDER SPENCER, JR., Redmond, WA (US); ANDY LAM, Seattle, WA (US); JAMIE PAUL BUCKLEY, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/259,665

(22) Filed: Oct. 28, 2008

(51) Int. Cl. G06F 17/30

(52) U.S. Cl. 707/776; 707/E17.108

(57) ABSTRACT

A system, media, and method for realtime popularity prediction for event and queries are provided. The popularity prediction is made by a prediction engine that is coupled to a search engine, a crawler, and a sentiment component. The prediction engine determines a change in popularity for an event or a query based on content provided by the crawler, sentiments identified by the sentiment component, and queries received in realtime by the search engine. The prediction engine may also use the content, sentiments, and queries to predict an outcome for a popularity based event.

### BACKGROUND

Conventionally, popularity for a celebrity or item is determined by requesting feedback on the celebrity or item via a poll of a small segment of a population. The conventional polls are generated by a survey agency or advertisement agency to learn about perceptions of consumers within the small segment of a population. The conventional polls of the small segment of the population are communicated to consumers in the small segment of the population by post mail or telephone. The feedback from these consumers is communicated by post mail or telephone to the conventional survey agency or the conventional advertising for processing.

The conventional survey agency or the conventional advertising agency processes the feedback received from the consumers within the small segment of the population to generate results regarding the perceptions of the popularity of the celebrity or the item. The results of the poll are then extrapolated to represent the entire population. The results of the polls may include comparisons among celebrities. The results of the polls may include comparisons among items, such as features of a consumer electronic device or an automobile.

The results of the poll are static and do not change until the small segment of the population is repolled by the conventional survey agency or the conventional advertising agency to receive additional feedback that is incorporated into the results. In turn, the results of the poll are used to rank the celebrities or items. Also, the results of the poll are used to develop advertising plans for the celebrity or item that was the subject of the conventional polls.

### SUMMARY

Embodiments of the invention include computer-readable media, computer systems, and computer-implemented methods to predict in realtime a popularity for an event and a query to predict in realtime an outcome for an event.

The computing system includes search engines, logs, and prediction engines. The computing system predicts a popularity for a query and an event. The computing system also predicts an outcome for an event. The search engines receive queries from a user and provide results to the user. The logs coupled to the search engines store browse data, purchase data, and queries issued by the user and other users of the search engine. The prediction engine predicts the popularity of the event or the popularity of a query based on, among other things, counts associated with the query or the event and aggregated behaviors for a group of users having log entries related to the query or the event. The prediction engine predicts the popularity of the event based on, among other things, a sentiment associated with the event and rate of change for the popularity of the event.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an exemplary computing environment for predicting popularity for queries and predicting popularity for events, according to embodiments of the invention;

FIG. 2 illustrates an exemplary method to determine sentiments associated with queries, according to embodiments of the invention; and

FIG. 3 illustrates an exemplary method to predict an outcome for an event, according to embodiments of the invention.

### DETAILED DESCRIPTION

This patent describes the subject matter for patenting with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described. Further, embodiments are described in detail below with reference to the attached drawing figures, which are incorporated in their entirety by reference herein.

As utilized herein, the term “component” refers to any combination of hardware, software, or firmware.

A search engine configured with a prediction engine generates popularity predictions for queries and events. Also, the prediction engine predicts an outcome of the events. The search engine receives queries and stores the queries in a log to identify changes in usage of queries. In certain embodiments, the prediction engine communicates with a monitor component to provide prediction of prices of goods or services using logs and indications of user interest in events, goods, or services.

A computer system predicts outcomes for events and popularity for events and queries based on popularity measures observed by a search engine and sentiments associated with the queries received by the search engine. The search engine is connected to client devices that generate user queries and transmit the user queries to the search engine. The outcomes and popularity are predicted by, among other things, monitoring changes in published website content and query usage.

As one skilled in the art will appreciate, the computer system includes hardware, software, or a combination of hardware and software. The hardware includes processors and memories configured to execute instructions stored in the memories. In one embodiment, the memories include computer-readable media that store a computer-program product having computer-useable instructions for a computer-implemented method. Computer-readable media include both volatile and nonvolatile media, removable and nonremovable media, and media readable by a database, a switch, and various other network devices. Network switches, routers, and related components are conventional in nature, as are means of communicating with the same. By way of example, and not limitation, computer-readable media comprise computer-storage media and communications media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read only memory (ROM), electrically erasable programmable read only memory (EEPROM), flash memory or other memory technology, compact-disc read only memory (CD-ROM), digital versatile discs (DVD), holographic media or other optical disc storage, magnetic cassettes, magnetic tape, magnetic disk storage, and other magnetic storage devices. These memory components can store data momentarily, temporarily, or permanently.

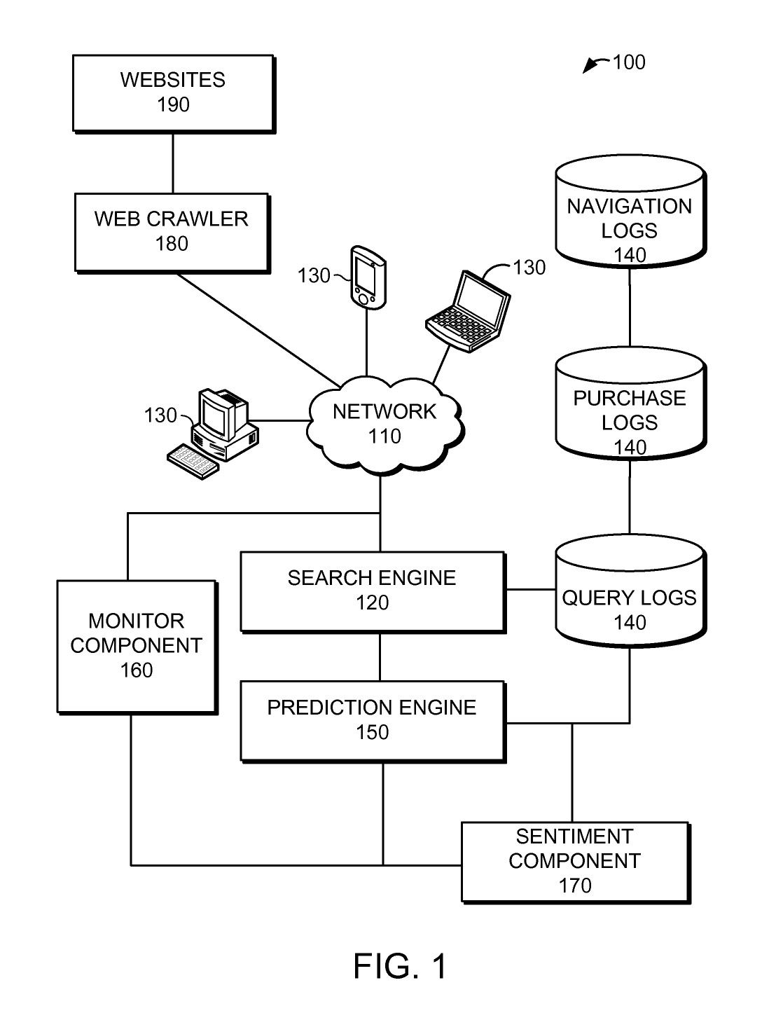

FIG. 1 illustrates an exemplary computing environment 100 for predicting popularity for queries and predicting popularity for events, according to embodiments of the invention. The computing environment 100 includes a network 110, a search engine 120, client devices 130, logs 140, a prediction engine 150, a monitor component 160, a sentiment component 170, a web crawler 180, and websites 190.

The network 110 is configured to facilitate communication between the search engine 120, client devices 130, and the web crawler 180. The network 110 may be a communication network, such as a wireless network, local area network, wired network, or the Internet. In an embodiment, the client devices 130 communicate user queries to the search engine 120 utilizing the network 110. In response, the search engine 120 communicates predictions of the popularity of the queries, predictions of the popularity of the events related to the queries, and predictions of the outcomes of the events to the client devices 130 over network 110.

The search engine 120 responds to user queries received from the client devices 130. The search engine 120 is configured for presenting query results in response to a user's query. The search engine 120 is communicatively connected to logs 140 that store the queries issued by users and query results returned to the users. In one embodiment, the search engine 120 connects to one or more web crawlers 180 that search the Internet and store updated website content or new website content in log 40. In some embodiments, the search engine 120 provides predictions to the users of the client devices 130. The predictions include popularity of an event, popularity of a query, and outcomes of an event.

The client devices 130 are utilized by a user to generate user queries and to receive query results and predictions that include popularity of an event, popularity of a query, and outcomes of an event. The client devices 130 include, without limitation, personal digital assistants, smart phones, laptops, personal computers, or any other suitable client computing device. The user queries generated by the client devices 130 may include terms that correspond to things that the user is seeking.

The logs 140 include query logs, purchase logs, and browser logs. The logs 140 store queries issued by the users of the client devices 130. The logs 140 store the terms of the query, the time the query was issued, a pointer to query results corresponding to the query, and user interaction behavior including dwell times and click-through rates. The query results include query results that are presented to the user and query results that are selected by the user. The logs 140 store counts for queries or content that represent an apparent popularity of the queries or content. The logs 140 store dates and times that the query was received by the search engine 120 or dates and times that the content was accessed by the users. In an embodiment, the logs 140 store a rate at which the query is received by the search engine and a rate at which content is accessed 360 by the same user or by different users. Moreover, the logs 140 may store transaction data for purchases made by the user. The logs 140 may also store an identifier, such as a media access address or internet protocol address, for each client device 130 and map the identifier for the client device 130 to queries included in the logs 140. In some embodiment, the user of the client device 130 may register a user name and password with the search engine 120 to have the queries issued by the user associated with a profile of the user. The logs 140 may also store identifiers for the users or the client devices 130. In an alternate embodiment, the identifier corresponding to the queries stored in the logs 140 may be a cookie that is a combination of an identifier of a client device 130 and an identifier of the user.

The prediction engine 150 forecasts a future popularity for a query or event bases on, among other things, data received from the logs 140, monitor component 160, sentiment component 170, and web crawler 180. The prediction engine 150 also forecasts an outcome for an event. In some embodiments, the event may include one of a purchasing a plane ticket, attending a conference, a popularity contest, an initial public offering, or a price for a commodity. The prediction may occur within a specified period of time after receiving the query or prior to a date and time of the event. The specified period of time may include a week, a bi-week, a month, a quarter, or a year. The predictor engine 150 returns the predictions to the search engine 120, which separately provides the client devices 130 with the predictions and the query results. In one embodiment, the prediction engine 150 returns the predictions to the search engine 120, which combines the predictions and query results and provides the client devices 130 with the combined prediction and query results.

The monitor component 160 is configured to identify one or more entities that may be the intended object of a query. An entity could be a name, event, person, a corporation, a government unit, a product, a sports team, a geographic location, etc. Once the monitor component 160 has identified one or more entities, the logs 140 store data related to each entity. Also, the monitor component 160 tracks past and current popularity of an entity that appears in the queries. The monitor component transmits in realtime changes in popularity to the prediction engine 150, which forecasts the future popularity of the entity. The monitor component 160 is configured to distinguish between legitimate queries submitted by individual users and fraudulent queries submitted by a client device 130: to attack a website by increasing traffic to the website, to inflate website rankings by increasing the website's importance within numerous search queries, or to inflate counts associated with content for a website associated with an entity to increase a popularity measure of the entity. The monitor component 160 may use a rate of change for the counts to detect suspicious activity. If the counts rate of change for an entity exceeds a threshold value, a weight assigned to the count can be lowered in order to mitigate against the fraudulent queries that inflate rankings for the entity. Therefore, abnormal rate of change values may discount the counts, and thus, the entity's popularity, by some amount. The amount may be relatively small or substantial depending on the circumstances. In an embodiment, the threshold value may be calculated based on the average rate of change for the counts associated with the entities, an average browsing rate, or an average historical hit rate. In other embodiments, when the monitor component 160 determines that a group of users or machines is contributing to a high access rate for an entity, then these users or machines may be identified to be untrustworthy or fraudulent and any counts attributed to these users or machines may be purged from the logs 140.

The sentiment component 170 parses the queries stored in the log 140 and assigns a sentiment to the query. Also, the sentiment component 170 may receive realtime queries from the monitor component 160 and assign sentiments to the realtime queries. The sentiment component 170 may also parse content stored in the logs 140, where the content is associated with a query to assign a sentiment to the content. The sentiment component 170 may receive new content or updated content from the web crawler 180, parse the new content and updated content and assign a sentiment to the new content or updated content. In an embodiment, the sentiment component 170 may store the assigned sentiments in the logs 140. In turn, the prediction engine 150 receives the sentiments from the sentiment component 170 and generates predictions for an outcome of an event and popularity of a query or popularity of an event. The sentiment component 170 may use term lists to assign sentiments. The content and queries may be parsed in real time to determine if an assigned sentiment should be positive, neutral, or negative. The sentiment component 170 may have a configurable time window, where the sentiment component 170 increases a frequency at which content or queries are parsed to assign sentiments. In some embodiments, the frequency at which content or queries for an entity are parsed increases as a critical date or time associated with the entity is within a month, week, day, or hour. In an embodiment, the sentiment component 170 may assign similar sentiments to queries or content that are related to query or content that is assigned a sentiment. For example if the query energy is assigned a positive sentiment, the sentiment component 170 may assign the queries oil drilling and oil exploration positive sentiments because of the relatedness of the queries.

The web crawler 180 retrieves and indexes websites 190 or content of the websites on the network 110. The web crawler 180 may store the content of the websites in the logs 140. In some embodiments, the web crawler 180 retrieves content specifying event dates. The web crawler 180 locates editorials or blogs that include terms related to an event or query stored in the log 140. The web crawler 180 communicates with the websites to the sentiment component 170, which assigns an appropriate sentiment to the website. The web crawler 180 may impact a popularity measure predicted by the prediction engine 150 for an entity by retrieving additional content for the entity, such as, but not limited to, an event or query. For example, if the prediction engine 150 is determining the popularity for Jennifer Lopez's concert sales the prediction engine could predict that the popularity will increase because the web crawler 180 retrieves more content from news articles or blogs about overwhelming interest in the concert.

The websites 190 are content that is accessible over the network 110. The websites 190 include text, images, graphics, audio, video, or any combination of the text, images, graphics, audio, and video. The content of the websites 190 may describe an entity and may be updated to reflect changes that correspond to the entity.

Accordingly, the computing environment 100 is configured with a prediction engine 150 that predicts outcomes of events and predicts future popularities for events and queries based on the realtime processing of queries received by a search engine 120 and analyzing logs 140 storing navigation data, purchase data, and previous queries from users of the search engine 120. In turn, the predictions are provided to the client devices 130 via the search engine 120.

One of ordinary skill in the art understands and appreciates the computing environment 100 has been simplified for description purposes. Also, one of ordinary skill in the art understands and appreciates that alternate operating environments are within the scope and spirit of this description.

In an embodiment, a prediction engine communicates with a sentiment component to determine a sentiment for a query or event. The sentiment is identified by parsing a query to locate terms include in lists for terms. Also, the sentiment is identified by parsing content associated with an event to locate terms include in lists for terms. The lists are used to assign an appropriate sentiment to a query or event. In turn, the sentiment is used by the prediction engine to predict a future outcome for an event or to predict a future popularity for the event or a query.

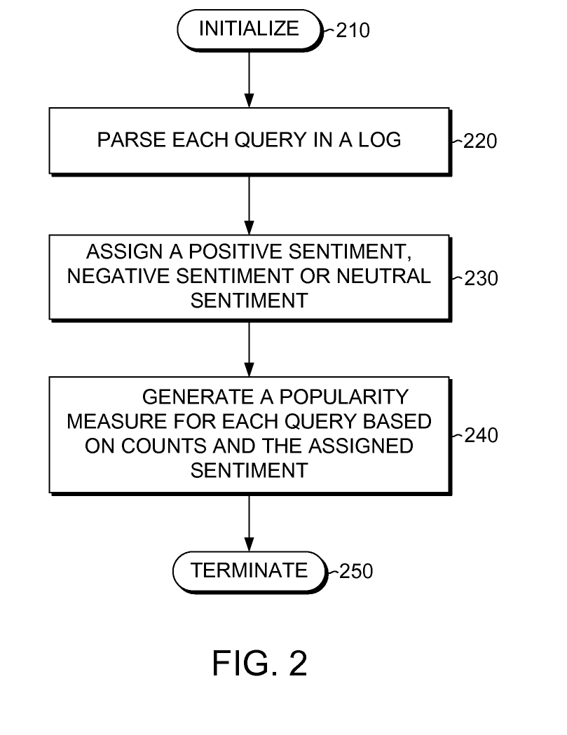

FIG. 2 illustrates an exemplary method to determine sentiments associated with queries, according to embodiments of the invention. The method initializes in the step 210 when a search engine receives a query and stores the query in log. In step 220, a sentiment component parses each query in the log to identify terms that are included in a white list, gray list, and red list. The sentiment component parses content associated with an event to identify terms that are included in a white list, gray list, and red list. In an embodiment, the white list includes terms assigned a positive sentiment, the gray list includes terms assigned a neutral sentiment, and the red list includes of terms assigned a negative treatment. In step 230, the sentiment component assigns a positive, negative, or neutral sentiment to the query or event based on the distribution of the terms in the white list, gray list, and red list. In step 240, a prediction engine generates a popularity measure for each query or events based on counts included in the query log and the sentiments assigned to the queries or events by the sentiment component. The method terminates in step 250.

In certain embodiments, a prediction engine is configured to predict an outcome of event. The prediction engine indentifies counts in a log for the event and counts in the log for queries related to the event. The prediction engine uses the identified counts and realtime data received from a monitor component on the rate of change of the counts to predict the outcome of the event. The prediction engine may also use sentiments received from a sentiment component to impact a prediction for the outcome of the event.

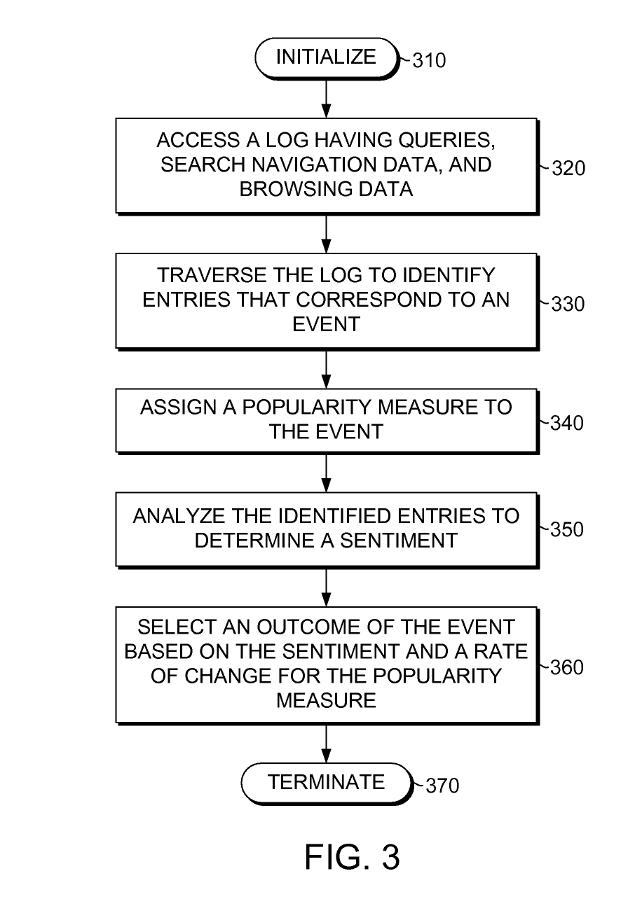

FIG. 3 illustrates an exemplary method to predict an outcome for an event, according to embodiments of the invention. The method initializes in the step 310 when a search engine receives a query and stores the query in log. In step 320 a prediction engine accesses a log having queries received by a search engine, search navigation data for users that access search results returned by the search engine, and browsing data received from client devices used by the users. In step 330, the prediction engine traverses the log to identify entries that correspond to an event of interest to a user. The log is updated to include queries received in realtime at the search engine. In certain embodiments, the event may include a popularity contest, media release, initial public offering, ticket sale, or price of an item. The entries may include terms of the query, dwell time for content associated with the event, and click through data associated with the content. In turn, the prediction engine assigns a popularity measure to the event based on a count of the identified entries that correspond to the event, in step 340. In step 350, the prediction engine analyzes the identified entries to determine a sentiment generated by a sentiment component and associated with the entries of the users that access content associated with the event. In step 360, the prediction engine selects an outcome of the event based on the sentiment of the users that access content associated with the event and a rate of change associated with the popularity measure assigned to the event using the log. A monitor component monitors the queries received in realtime to identify significant changes in sentiment or popularity measures for entries in the log and communicates the significant changes to the prediction engine. A seasonal period associated with the queries that are received in realtime may impact the popularity measure of the event. For instance, certain queries may be more popular during holiday seasons, which may erroneously impact a popularity measure of the event. In an embodiment, the popularity measure corresponding to the event may increase based on updates processed by a web crawler that stores the updates in the log. An increase in a rate of publication of content related to the event observed by the web crawler, generates increases in the assigned popularity measure corresponding to the event. The popularity measure associated with the event may be imputed, by the prediction engine, to queries related to the event. The method terminates in step 370.

In an alternate embodiment, the prediction engine may predict a future popularity of the queries based on changes in popularity of an event related to the queries. The prediction engine may receive notifications including vectors from a monitor component of a significant change in a rate of access for content related to event. The monitor component tracks, in realtime, queries for the event and updates to content associated with the event to identify vectors that represent the rate of change of interest in the event. These notifications received by the prediction engine may be used to predict the future popularity for the queries related to the event.

In summary, media, methods, and computing systems predict an outcome for an event, predict a future popularity for an event, or predict a future popularity for a query. The prediction engine uses realtime information to make the predictions and sentiments gleaned from the realtime information to verify that the predictions are current. Additionally, a rate of change is monitored by the computing system to discard suspicious queries received by the computing system to prevent manipulation of the predictions generated by the computing system.

The foregoing descriptions of the embodiments of the invention are illustrative, and modifications in configuration and implementation will occur to persons skilled in the art. For instance, while the embodiments of the invention have generally been described with relation to FIGS. 1-3, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the embodiments of the invention are accordingly intended to be limited only by the following claims.

We claim:

1. A computer-implemented method to forecast the outcome of an event, the computer-implemented method comprising:
accessing a log having queries received by a search engine, search navigation data for users that access search results returned by the search engine, and browsing data received from client devices used by the users;
traversing the log to identify entries that correspond to an event of interest to a user;
assigning a popularity measure to the event based on a count of the identified entries that correspond to the event;
analyzing the identified entries to determine a sentiment associated with the users that access content associated with the event; and
selecting an outcome of the event based on the sentiment of the users that access content associated with the event and a rate of change associated with the popularity measure assigned to the event using the log.

2. The computer-implemented method of claim 1, wherein the event is one of: a popularity contest, media release, initial public offering, ticket sale, or price of an item.

3. The computer-implemented method of claim 1, wherein the entries include terms of the query, dwell time for content associated with the event, and click through data associated with the content.

4. The computer-implemented method of claim 1, wherein the popularity measure corresponding to the event increases based on updates processed by a web crawler that stores the updates in the log.

5. The computer-implemented method of claim 4, wherein an increase in a rate of publication of content related to the event observed by the web crawler, generates increases in the assigned popularity measure corresponding to the event.

6. The computer-implemented method of claim 4, wherein the popularity measure associated with the event is imputed to queries related to the event.

7. The computer-implemented method of claim 4, wherein a future popularity of the queries is predicted based on changes in the popularity of an event related to the queries.

8. The computer-implemented method of claim 1, wherein the log is updated to include queries received in realtime.

9. The computer-implemented method of claim 8, wherein a seasonal period associated with the queries that are received in realtime impact the popularity measure of the event.

10. The computer-implemented method of claim 8, further comprising monitoring the queries received in realtime to identify significant changes in sentiment or popularity measures for entries in the log.

11. One or more computer-readable media storing instructions for performing a method to determine the sentiment for a query, the method comprising:
parsing each query in a log to identify terms that are included in a white list, gray list, and red list;
assigning a positive, negative, or neutral sentiment to the query based on the distribution of the terms in the white list, gray list, and red list; and
generating a popularity measure for each query based on counts included in the query log and the sentiments assigned to the queries.

12. The media of claim 11, wherein the white list consists of terms that assigned a positive sentiment

13. The media of claim 11, wherein the gray list consists of terms that are assigned a neutral sentiment.

14. The media of claim 11, wherein the red list consists of terms that are assigned a negative treatment.

15. The media of claim 10, wherein each industry has a white list, a gray list, and a red list.

16. A computer prediction system to forecast future popularity for queries, the prediction system comprising:
one or more search engines configured to receive queries from a user and to provide results to the user;
one or more logs coupled to the one or more search engines and configured to store purchase transaction data, browsing data, and queries issued by users, who submit queries to the one or more search engines; and
one or more prediction engines configured to forecast a future popularity of queries that the user is likely to issue in a certain time period based on queries, purchases, and aggregated behaviors for a group of users that issue the queries.

17. The computing system of claim 16, further comprising one or more monitor components configured to monitor queries issued in realtime to the search engine.

18. The computing system of claim 17, further comprising one or more crawler components configured to locate new website content or updated website content related to queries stored in the one or more query logs and to notify the monitor component of a large number of new website content or updated website content regarding a particular subject from a number of different websites.

19. The computing system of claim 16, further comprising one or more sentiment components configured to identify a sentiment associated with queries issued by the user.

20. The computing system of claim 19, wherein the one or more sentiment components select a vector to forecast a future popularity of the queries and provide the vector to the prediction engine, which utilizes the vector to predict a change in the popularity measure associated with the queries.
